(19) United States
(12) Patent Application Publication
(10) Pub. No.: US 2006/0044975 A1
(43) Pub. Date: Mar. 2, 2006

(54) Recording reproducing method and recording reproducing device

(75) Inventors: Tomoyuki Miyake, Nara (JP); Kyoji Kasuga, Kyoto (JP)

Correspondence Address: EDWARDS & ANGELL, LLP, P.O. BOX 55874, BOSTON, MA, 02205, US

(73) Assignee: Sharp Kabushiki Kaisha, Osaka (JP)

(21) Appl. No.: 10/538,302

(22) PCT Filed: Nov. 18, 2003
(86) PCT No.: PCT/JP03/14688

§ 371 Date: Jun. 9, 2005

(30) Foreign Application Priority Data
Dec. 16, 2002 (JP) 2002-364294

(51) Int. Cl. G11B 7/00; G11B 7/09

(52) U.S. Cl. 369/53.2; 369/47.1

(57) ABSTRACT

A recording/reproducing apparatus is provided that is used by a plurality of users and simplifies file management in a storage medium in which many content items are stored. With the use of the recording/reproducing apparatus (1), when recording and reproducing contents on and from an optical disk D, recording and reproducing history information is recorded and updated for each content item and for each user who has recorded the content, will reproduce the content, and is reproducing the content. The recording and reproducing history information includes information, for example, indicative of whether or not each content item has been reproduced, and a reproducing restriction set on each content item. Displaying such information realizes simple file management. For example, it is possible to fetch contents that have not been commonly reproduced among plural users, or delete contents that have been reproduced by all users, both quickly and reliably.

### TECHNICAL FIELD

The present invention relates to a method and an apparatus for recording and reproducing image information and other kinds of information. The present invention particularly relates to a method and an apparatus used by a plurality of users for recording and reproducing contents such as motion images, audios, or television broadcasting programs.

### BACKGROUND ART

In these years, with the performance improvement of random access storage media such as a harddisk drive, recording/reproducing apparatuses capable of recording and reproducing digital compressed images have been put to actual practice.

In one example of recording/reproducing apparatuses in the market, recorded programs are managed so that the programs are classified as either “reproduced” or “not reproduced,” and the status “reproduced” is displayed when even a portion of the recorded program is reproduced. Further, in this exemplary recording/reproducing apparatus, information about recorded or reproduced program is displayed.

Further, in a recording/reproducing apparatus described in Japanese Laid-Open Patent Publication No. 295558/2000 (Tokukai 2000-295558, publication date: Oct. 20, 2000) for example, a managing method of recorded programs is proposed in which reproduced history of recorded programs is graphically displayed using a designated area.

However, none of these techniques takes into consideration the situation where television broadcasting programs are viewed by plural viewers (users who reproduce programs) at the same time. That is, the foregoing techniques do not take into account the situation where plural viewers are involved.

On the contrary, in Japanese Laid-Open Patent Publication No. 175117/2000 (Tokukai 2000-175117, publication date: Jun. 23, 2000), such a television receiving set is described that recognizes viewers among a plurality of registered users, and that determines the need to set a viewing restriction on each program according to user information of the registered users.

Note that, Japanese Laid-Open Patent Publication No. 35092/2001 (Tokukai 2001-35092, publication date: Feb. 9, 2001) describes a removal memory, removal memory drive, and a security managing method. This publication discloses recording user managing information in a storage medium such as an external memory for a personal computer (PC), for example.

According to the conventional arrangement, however, file management (content management) is not always convenient in a recording/reproducing apparatus that uses a storage medium shared by plural users and storing many contents items.

That is, the arrangement described in Tokukai 2000-175117 is only for image information to be broadcasted, and is not for viewing image information stored in the storage medium. Therefore, it is not known how the contents (files) stored in the storage media are managed.

The present invention was made in view of the above problems, and an object of the present invention is to provide a recording/reproducing method and a recording/reproducing apparatus that are used by plural users and for facilitating and simplifying file management in a storage medium storing many contents items.

### DISCLOSURE OF INVENTION

According to the present invention, to attain the foregoing object, there is provided a recording/reproducing method for a recording/reproducing apparatus which records and reproduces contents on and from a storage medium, the method including the step of updating history information in which content information of contents stored in the storage medium is associated with user information of a plurality of users using the recording/reproducing apparatus and in which a reproducing entry indicative of whether the users have reproduced the contents is contained, the history information being updated responsive to reproduction of the contents and in regard to the reproducing entry concerning a user who has reproduced the contents.

On the storage medium, contents such as motion images, audios, and television broadcasting programs are stored. The storage medium is used (shared) by plural users.

The content information of the contents contains dates and times when the contents were stored (recorded), recorded channels, recorded times, subjects (classification such as dramas, movies, etc.). The content information may be entered in the storage medium, or in the recording/reproducing apparatus that records and reproduces information on and from the storage medium. However, considering increase of storage capacity, it is desirable that the content information be stored in the storage medium detachably provided in the recording/reproducing apparatus.

The user information of the users of the recording/reproducing apparatus may be entered in the storage medium, or in the recording/reproducing apparatus that records and reproduces information on and from the storage medium. The user information is entered at least before the contents are reproduced or recorded. That is, the user information may be entered every time the contents are stored and reproduced, for example. Alternatively, the user information may be entered by checking entered information before reproduction, for example. Considering this, it is desirable to store the user information in the storage area of, for example, a semiconductor memory or harddisk provided in the recording/reproducing apparatus.

The history information (recording and reproducing history information) in which the content information of the contents stored in the storage medium and the user information of the plural users of the recording/reproducing apparatus are associated with each other refers to information of recording or reproducing history. Thus, the history information can be expressed as recording or reproducing history information.

The history information contains reproducing history (reproducing entry) concerning each user and each content item. The history information may also contain recording history (recording entry) concerning a user who has recorded a content item. The history information may be entered in the storage medium or in the recording/reproducing apparatus that records and reproduces information on and from the storage medium. However, for ease of history listings in the apparatus, it is desirable to store the history information in a storage area in the recording/reproducing apparatus, or in a storage device different from the storage medium. Examples of the former include fixed memories such as semiconductor memory or HDD. Examples of the latter include exchangeable memory such as PC card memory.

Note that, as used herein, “reproducing contents” includes reproducing the contents when it is being recorded.

According to the arrangement, when a user reproduces a content item, the entry (reproducing entry) associated with the content item and contained in the reproduced history of the user in the history information is updated (modified) to indicate that it has been reproduced. In order to update the history information according to reproduction of the contents, the user may be authenticated before reproducing the contents, for example. In this case, the authenticated user is regarded as the user who has reproduced the contents, and the history information is updated.

Thus, by referring to the history information, the reproduced history of each content item stored in the storage medium can be managed for each user. Therefore, by referring to the history information of other users, it is possible to prevent contents, which other users have not reproduced, from being accidentally deleted. For this purpose, a table may be created and displayed in which content item stored in the storage medium are associated with the users, for example. In this manner, reproduced histories of the plural users can be checked in regard to individual content items. Thus, the contents will not be deleted accidentally.

Further, it is also possible to determine whether or not the storage medium contains a content item reproduced by all users, for example. Thus, an unnecessary content item can be deleted if it has been reproduced by all users.

Thus, a recording/reproducing method is provided that allows for easy and convenient file management (content management) in a storage medium used by plural users and containing many content items.

That is, the method may be adapted so that an unreproduced content item common to plural users reproducing (viewing) information from the storage medium in the recording/reproducing apparatus is extracted using, for example, the reproducing entry. Further, the method may be adapted so that a content item reproduced by all users entered in the recording/reproducing apparatus are found and deleted using, for example, the reproducing entry. By performing these operations quickly and reliably, file management and user management can be simplified.

The storing and reproducing method can be also described as follows. Entry is made for users who record and reproduce on and from the storage medium and the contents stored in the storage medium. Then, history information of contents recorded and reproduced by the users includes at least names of the users (viewers) and classification of whether or not the users have reproduced the contents. Thus, users operating the storing apparatus are recognized, and the information is managed.

The history information includes viewers, names of contents, and classification of whether or not the viewers have reproduced the contents. In this case, as the amount of contents to be recorded and reproduced in the recording/reproducing apparatus increases, the amount of information associated with the history information increases accordingly. Thus, when the amount of information exceeds the storage capacity, the information may no longer be stored. Thus, if the history information is stored in a storage medium detachably provided in the recording/reproducing apparatus, there will be no shortage of storage area. However, the information can be accessed only when the storage medium is inserted in the apparatus. As a result, a complete list cannot be acquired to check who have not reproduced contents including the storage medium. In this case, it is more convenient to store the information in a designated storage area in the recording/reproducing apparatus.

According to the arrangement, to attain the foregoing object, the recording/reproducing method of the present invention further includes the step of displaying the user information, registered in the recording/reproducing apparatus, so as to allow for selection of users using the recording/reproducing apparatus.

According to the arrangement, user information of a user of the recording/reproducing apparatus is entered beforehand in the recording/reproducing apparatus by the user, for example. Then, when the user uses the recording/reproducing apparatus, the registered user information is displayed in the recording/reproducing apparatus so as to allow for selection of a user using the recording/reproducing apparatus.

Therefore, from the entered user information for example, a user reproducing contents is selected as a user using the recording/reproducing apparatus. When recording contents for example, a user recording contents is selected as a user using the recording/reproducing apparatus.

As a result, when updating the reproduced history according to reproduction of the contents, the selected user can be regarded as a user reproducing the contents, for example. Because the user reproducing the content is specified by being selected based on the registered user information, various settings such as entering user names or setting password will not be required.

Further, the user information is stored in the recording/reproducing apparatus that records and reproduces information on and from the storage medium. Therefore, the user information need not be read out from the storage medium. Thus, the user information, especially the information associated with the reproduced history, can be displayed quickly during the adjustment for storing and reproducing information in and from the storage medium. For example, in the case of optical disks, the information can be quickly displayed during laser power adjustment and disk tilt correction. It is also possible to finish selecting users of the contents during the adjustment.

The storing and reproducing method can be also described as follows. The recording/reproducing apparatus managing plural users contains the information storage section for registering user information of users using the recording/reproducing apparatus, and users of contents to be recorded on and reproduced from the storage medium are selected from the user information registered in the user information storage section.

According to the arrangement, to attain the foregoing object, the recording/reproducing method of the present invention further includes the steps of: registering a user of the recording/reproducing apparatus in a storage area of the recording/reproducing apparatus at or after the startup of the recording/reproducing apparatus; and setting, when the user has recorded contents on the storage medium, a recording entry in the history information in regard to the user registered in the user registering step, so as to indicate that the user has recorded contents on the storage medium, or, when the user has reproduced contents from the storage medium, updating the reproducing entry in the history information in regard to the user registered in the user registering step, the setting or update being carried out at a point in between the recording/reproducing apparatus being started up and the recording/reproducing apparatus being turned off.

According to the arrangement, users selected or newly registered at the startup of the recording/reproducing apparatus are set for subsequent recording or reproducing. The user settings may be carried out for a plurality of users. The user information is updated in this manner. More specifically, at the startup of the apparatus, users (may or may not accompany other users) are entered as the users of the recording/reproducing apparatus. The history information of these users is updated when the users record or reproduce contents later. For example, when contents are recorded, a recording item is entered in the history information concerning the user who made the recording. When contents are reproduced, the reproducing entry in the history information is updated concerning the user who has reproduced the contents.

Therefore, in reproducing or recording a plurality of contents, it is not required to enter or update the user information for each content item.

The storing and reproducing method can be also described as follows. At the startup of the recording/reproducing apparatus used by plural users, a user who has started up the apparatus, or users who will reproduce or record contents together are entered, and the user information and the stored and reproduced history information of each content item are automatically updated to indicate that the users have reproduced or recorded content, depending on whether the content was reproduced or recorded.

According to the arrangement, to attain the foregoing object, the recording/reproducing method of the present invention further includes the step of setting a deletion restriction entry in regard to a desired content item, the deletion restriction entry indicative of whether deletion of content is allowable or unallowable, and the deletion restriction entry being contained in the history information or being contained in the content information and associated with the history information.

When the history information contains the deletion restriction entry, the deletion restriction entry can be set for each user and each content item. When the deletion restriction entry is contained in the content information and associated with the history information, the deletion restriction entry, which becomes common to all users in this case, can be set for each content item.

According to the arrangement, deletion restriction may be set for a desired content item, so that the content will not be deleted. Thus, contents with the deletion restriction cannot be deleted. By canceling deletion restriction, the contents can be deleted. When contents with the deletion restriction are to be deleted, a warning may be issued.

In the case where a certain content item has not been reproduced by all users for example, deletion restriction is imposed on the content item. In this case, by referring to the reproducing entry of each user concerning this content item, the presence or absence of a user who has not reproduced the content item is determined, and common deletion restriction is set for all users. In this manner, the content is prevented from being deleted when it has not been reproduced by all users. That is, the method prevents contents from being deleted even if it has not been reproduced by all users.

Further, for example, a deletion restriction entry may be set when recording contents, and the deletion restriction may be cancelled when all users have reproduced the contents. Further, for example, the deletion restriction entry may be set when recording contents, and the deletion limit may be cancelled after a predetermined period. In this case, when the deletion restriction is canceled, the subjected contents may be deleted. That is, the contents reproduced by all users may be deleted automatically. It is also possible to delete contents automatically after a lapse of a predetermined time period from the time of recording. According to this arrangement, unnecessary contents will not be kept for an extended time period.

According to the arrangement, the deletion restriction entry may be contained in at least one of the history information and the content information. Also, the deletion restriction entry may be associated with the history information or the user information.

The storing and reproducing method can be also described as follows. Based on the user information and stored and reproduced history information registered for each of the stored content items, the deletion restriction is imposed on the content to be protected from deletion, or a warning may be issued for deletion, when the content have not been reproduced by all users.

According to the arrangement, to attain the foregoing object, the recording/reproducing method of the present invention further includes the steps of creating, based on the history information, a table in which contents represented by the content information and users represented by the user information are associated with each other; and displaying the table.

According to the arrangement, the history information registered for each of the content items in the storage medium is read out and displayed in a table to indicate a reproducing status of each content item for each user.

The table contains information concerning contents not reproduced by the user, and information concerning contents reproduced by a plurality of specified users and all subjected users.

This enables contents not reproduced by the viewer or contents reproduced by a plurality of specified users and all subjected users to be displayed and selected, thereby improving convenience and ease of listing. Also, with the table, filing work for deletion, storage, etc. can be carried out both easily and reliably.

According to the arrangement, to attain the foregoing object, the recording/reproducing method of the present invention further includes the steps of: entering and storing user information containing at least identification information specific to a user, the user information being entered and stored for at least one user of a recording/reproducing apparatus which records and reproduce contents on and from a storage medium; storing history information in which the user registered in the user information is associated with the contents, the history information being stored for each content item recorded on the storage medium; receiving a reproducing request for the recorded content item from a user registered in the user information; checking the users contained in the history information with the user who has made the reproducing request, in regard to the content for which the reproducing request was made; making, when the users accord, instructions for reproducing the content, and updating, after reproducing the content, the history information so that a combination of the content and identification information for specifying the user who has made the reproducing request includes additional information which indicates that the content has been reproduced; and outputting information indicative of a relationship between (i) the identification information for specifying the user who has made the reproducing request, (ii) the content information, and (iii) the presence or absence of information which indicates that the content has been reproduced.

According to the arrangement, the user-specific information such as user names is entered and stored in memory means (storage area) such as memory, and the user information is associated with each content information to be stored in the storage medium. Thus, there is a clear relationship between contents and users.

Next, control means, for example, such as CPU, receives the entered user information and a request for reproducing the stored contents. Then, the control means checks the entered user information with the history information of the contents, so as to determine whether or not the user having issued the reproduction request is a valid user to reproduce the contents.

When there is a match, instructions for reproducing the contents are made. After the contents are reproduced, the history information is updated so that a combination of the content and identification information for specifying the user who has made the reproducing request includes additional information which indicates that the reproduced content has been reproduced. Then, the history information is stored in the memory means such as memory. As used herein, “adding information that indicates that the content has been reproduced” includes modifying the entry (reproducing entry) in the reproduced history (viewed history), which indicates whether or not the user has reproduced (viewed) the contents, so that the status changes from “unreproduced” to “reproduced,” for example. Also, information indicative of a relationship between (i) the identification information for specifying the user, (ii) the content information stored in the storage medium, and (iii) the presence or absence of information which indicates that the content has been reproduced is sent to, for example, an external display device.

Thus, when plural users share a single storage medium, contents recorded on the storage medium are managed by being associated with the user information and the information indicative of whether or not the users have reproduced the contents. Therefore, users other than the current user can also check the reproducing status of the contents, so as to determine that the reproduced contents are deletable. Deleting contents allows the storage medium to restore its storage capacity. Thus, new contents can be stored.

In addition to the classification indicative of whether or not the contents have been reproduced, information prohibiting deletion of the contents may also be set. Thus, even when the contents have been reproduced, it is prevented from being deleted by a third party who is not associated with the contents. Since the stored contents can be protected from deletion, this is desirable when the contents are to be stored for a certain period of time or permanently.

According to the arrangement, to attain the foregoing object, there is provided a recording/reproducing apparatus for recording and reproducing contents on and from a storage medium, the recording/reproducing apparatus including: a user information managing section for managing user information concerning a plurality of users of the recording/reproducing apparatus; and a history information managing section for managing history information in which content information of contents recorded on the storage medium is stored, and in which a reproducing entry indicative of whether the contents have been reproduced by users is contained, wherein the history information managing section updates the reproducing entry responsive to reproduction of the contents and in regard to a user who has reproduced the contents.

The user information management section of the recording/reproducing apparatus manages the user information of the users of the recording/reproducing apparatus. The user information contains user names, passwords, and other attributes.

In the storage medium, contents such as motion images, audios, and television broadcasting programs are recorded. The storage medium is used (shared) by plural users.

The content information of the contents contains dates and times when the contents are stored (recorded), recorded channels, recorded times, subjects (classification such as dramas or movies, etc.). Therefore, in order to know subjects of the contents, the separately stored content information is displayed in the screen.

The history information management section of the recording/reproducing apparatus manages the history information in which the content information is associated with the user information. The stored and reproduced history contains an entry (reproducing entry) indicative of whether or not the users have reproduced the contents. When contents and a user are specified in the history information, the reproducing entry concerning the specified contents and user can be acquired, for example. The history information may also contain recording history (recording entry) concerning users who have recorded contents. The history information may be registered in a designated storage area provided in the recording/reproducing apparatus, or in the storage medium, for example.

Responsive to reproduction of the contents, the history information management section updates the history information. Specifically, the entry (reproducing entry) in the reproduced history of the contents is changed to a reproduced (viewed) status.

Note that, as used herein, “reproducing contents” includes reproducing the contents when the contents are being recorded. In order to update the history information in response to reproduction of the contents, the users may be authenticated using authentication means before reproducing the contents, for example. In this case, the authenticated user is regarded as the user who has reproduced the contents, and the history information is updated.

Thus, the reproduced histories of the contents stored in the storage medium can be managed for each of the users. Therefore, with reference to history information of other users, it is possible to prevent contents, which other users have not reproduced, from being accidentally deleted. For this purpose, a table may be created and displayed in which the contents stored in the storage medium are associated with and the history information, for example. In this manner, the reproduced histories of the plural users can be checked in regard to individual content items. Thus, the contents will not be deleted accidentally.

Further, it is also possible to determine whether or not the storage medium contains contents reproduced by all users, for example. Thus, unnecessary contents can be deleted.

Thus, a recording/reproducing method is provided that allows for easy and convenient file management (content management) in a storage medium used by plural users and containing many content items. That is, unreproduced contents common to the plural users is extracted. Further, contents reproduced by all users are deleted. By performing these operations quickly and reliably, file management and user management can be simplified.

The recording/reproducing apparatus can be also described as follows. Viewers are entered for each of the content items recorded on the storage medium in the recording/reproducing apparatus. Then, the information of whether or not the users entered for the contents have reproduced the contents is at least stored and managed in the storage medium or the storage section provided in the recording/reproducing apparatus.

According to the arrangement, to attain the foregoing object, the recording/reproducing apparatus of the present invention includes: a storage area, provided in the recording/reproducing apparatus, for enabling the user information managing section to register the user information; and a display control section for displaying listings of users whose user information is stored in the storage area, so as to allow for user selection by users using the recording/reproducing apparatus.

In the storage area of the recording/reproducing apparatus, user information of the users of the recording/reproducing apparatus are registered and stored. The storage area may be a rewritable semiconductor memory such as a flash memory. Further, the storage area may be a removal storage medium detachably provided in the recording/reproducing apparatus. By being detachable, the medium can be installed in other recording/reproducing apparatuses, and the same effect can be obtained therein.

In the recording/reproducing apparatus, the user information registered in the storage area is displayed, for example, on the display panel by the display control. Using the display control section, users are selected according to the user information displayed on the display panel. For example, a user using the recording/reproducing apparatus is selected by detecting the selection made by moving a pointer on the display panel using the display control section. The display control section is realized by the display panel and the pointing device, for example.

According to the arrangement, in selecting content viewers, the user information registered in the storage area is used. Therefore, various settings, for example, such as entering user names and setting passwords will not be required.

That is, when the user information management section detects reproduction of contents for example, a method for specifying users such as entering user names or setting passwords are required, for example. According to the arrangement, selection can be made only by using the previously entered user information. Thus, users can be specified more easily than entering or setting new information.

Further, since the user information is not read out from the storage medium, the user information can be fetched and displayed quickly regardless of the adjustment time, which may be required by the storage medium to start reproducing.

Rewritable optical disks such as DVD require an initialization time (the time required for adjusting various reproducing parameters, such as laser power, to enable reproducing or recording). However, according to the arrangement, even when such a storage medium is used, necessary user information can be fetched before reading information from the storage medium. Also, selection of contents viewers can be finished during the adjustment time.

The recording/reproducing apparatus can be also described as follows. The user information storage section (storage area) is provided for registering user information of users of the recording/reproducing apparatus and users of contents to be recorded on and reproduced from the storage medium are selected from the user information registered in the user information storage section.

According to the arrangement, to attain the foregoing object, in the recording/reproducing apparatus of the present invention including a user setting section, the history information managing section sets, when the user has recorded contents on the storage medium, a recording entry in the history information in regard to the user set in a user setting section, so as to indicate that the user has recorded contents on the storage medium, or the history information managing section updates, when the user has reproduced contents from the storage medium, the reproducing entry in the history information in regard to the user set in the user setting section, the setting or update being carried out at the startup of the recording/reproducing apparatus or after the startup of the recording/reproducing apparatus.

According to the arrangement, the history information managing section updates the history information so that the users set at the startup of the recording/reproducing apparatus are set for subsequent recording or reproducing. More specifically, at the startup of the apparatus, users (may or may not accompany other users) are set. The history information of these users is updated when the users record or reproduce contents later.

Therefore, in reproducing or recording a plurality of contents, it is not required to enter or update the user information for each content item.

The recording/reproducing apparatus can be also described as follows. At the startup of the recording/reproducing apparatus used by plural users, a user who has started up the apparatus, or users who will reproduce or record contents together are entered, and the user information and the stored and reproduced history information of each content item are automatically updated to indicate that the users have reproduced or recorded content, depending on whether the content was reproduced or recorded.

According to the arrangement, to attain the foregoing object, in the recording/reproducing apparatus of the present invention, the history information or the content information includes a deletion restriction entry indicative of whether deletion of content is allowable or unallowable, and the deletion restriction entry in the content information is associated with the history information, and the history information managing section sets the deletion restriction entry in regard to a desired content item.

According to the arrangement, a deletion restriction entry is set on a desired content item so as to prevent it from being deleted. The deletion restriction entry indicates whether or not the contents can be deleted, and is contained in the history information or the content information.

Contents with the deletion restriction cannot be deleted. By canceling the deletion restriction, the contents can be deleted. When the contents with the deletion restriction are to be deleted, a warning may be issued. In order to set or cancel the deletion restriction, a common value may be set for all content users so that the deletion restriction is canceled when all users have reproduced the contents, or the deletion restriction may be set when even one viewer has not reproduced the contents.

In the case where certain content has not been reproduced by all users for example, deletion restriction is imposed on the content. In this manner, the content is prevented from being deleted when it has not been reproduced by all users.

Further, for example, a deletion restriction entry may be set when recording contents, and the deletion restriction may be cancelled when all users have reproduced the contents. Further, for example, the deletion restriction entry may be set when recording contents, and the deletion restriction may be cancelled after a predetermined period. In this case, when the deletion restriction is canceled, the subjected contents may be deleted. The deletion restriction is set for each content item, and therefore, generally, the deletion restriction is contained in the content information, and a reproducing status is set by referring to the history information. According to this arrangement, unnecessary contents will not be kept for an extended time period.

According to the arrangement, the deletion limit item may be contained in at least one of the history information and the content information. For example, when the deletion restriction entry is contained in the history information, the deletion restriction entry can be set for each user and for each content item. Further, when the deletion restriction entry is contained in the content information and associated with the history information, the deletion restriction entry, which becomes common to all users in this case, can be set for each content item. Also, the deletion restriction item may be associated with the history information or the user information.

The recording/reproducing apparatus can be also described as follows. When the contents have not been reproduced by all users, the deletion restriction is added to prevent the contents from being deleted, or a warning is issued against deletion, based on the user information entered for each of the recorded content items.

According to the arrangement, to attain the foregoing object, the recording/reproducing apparatus of the present invention includes a table display section for creating, based on the history information, a table in which the user information managed by the user information managing section is associated with the content information of the contents recorded on the storage medium, and displaying the table.

According to the arrangement, the table display section displays a table, created based on the history information, on the display panel for example. Thus, for individual content items, the reproducing statuses (reproducing table) of plural users can be checked. The display panel may be a panel for displaying control information of the recording/reproducing apparatus, or a panel for displaying image information recorded or reproduced on and from the recording/reproducing apparatus, for example. The display panel may be incorporated with the recording/reproducing apparatus, or may be an external panel separately provided from the recording/reproducing apparatus externally.

According to the arrangement, the history information entered for each of the content items in the storage medium is read and displayed in a table to indicate a reproducing status of each content item for each user. This enables contents not reproduced by the viewer or contents reproduced by a plurality of specified users and all subjected users to be displayed and selected, thereby improving convenience and ease of listing. Also, with the table, filing work for deletion, storage, etc. can be carried out both easily and reliably.

The recording/reproducing apparatus can be also described as follows. The recording and reproducing history information which is stored for each of the content items in the storage medium is read and displayed in a list showing a reproducing status of contents for each user stored in the user information storage section provided in the recording/reproducing apparatus.

In addition to the arrangement, in the recording/reproducing apparatus of the present invention, the reproducing entry contained in the history information managed by the history information managing section includes an entry indicative of date and time that the content was reproduced by the user. The arrangement simplifies management by referring to reproduced dates and times. For example, when a predetermined time period has passed since the reproduced dates and times, the contents may be protected from deletion because, in this case, the subject of the contents might have been forgotten.

In addition to the arrangement, in the recording/reproducing apparatus, when updating the reproducing entry for the user who has reproduced the content, the history information managing section sets the deletion restriction entry such that the user is allowed to delete the content. In this manner, responsive to content reproduction, the deletion restriction entry for each user may be set to “deletable,” since deletion of the contents is unlikely to pose a problem if it has been reproduced. In this case, the recording/reproducing apparatus may actually delete the contents when the deletion restriction entry is set for all users.

In addition to the arrangement, in the recording/reproducing apparatus, the deletion restriction entry set by the history information managing section also sets reproducing restriction for the users. In this manner, the entry for deletion restriction may be set for each user and for each content item. The arrangement simplifies user management even when the recording/reproducing apparatus is used by a plurality of users.

As described above, in the storing and reproducing method and recording/reproducing apparatus of the present invention, information indicative of whether the user has reproduced or has not reproduced contents (reproduced history) is entered for each content item recorded on the storage medium used by plural users.

Thus, in audios visual (AV) devices shared by plural users, unreproduced contents common to plural users are read, for example. Further, contents reproduced by all users are deleted. By performing these operations quickly and reliably, file management and user management can be simplified.

Further, when the recording/reproducing apparatus has a storage area (user information storage area) for entering users of the apparatus, user entry is made beforehand in the storage medium. In this way, the users entered in the storage area can be quickly displayed at the startup, even when the storage medium is not inserted in the apparatus and irrespective of, for example, the history information stored for each content item in the storage medium, thereby setting users carrying out recording or reproducing in the recording/reproducing apparatus.

Furthermore, by making selection from the pre-entered user information using the display control section such as a pointing device, plural users can be managed both easily and reliably.

For a fuller understanding of the nature and advantages of the invention, reference should be made to the ensuing detailed description taken in conjunction with the accompanying drawings.

### BRIEF DESCRIPTION OF DRAWINGS

FIG. 1 is a block diagram illustrating one embodiment of a recording/reproducing apparatus according to the present invention.

FIG. 2 is a plan view illustrating a portion of the recording/reproducing apparatus.

FIG. 3 is a plan view illustrating another portion of the recording/reproducing apparatus.

FIG. 4 is a plan view showing one example of a display screen of the recording/reproducing apparatus.

FIG. 5 is a flow chart representing storing and reproducing operations in the recording/reproducing apparatus.

FIG. 6 is a plan view showing another example of the display screen of the recording/reproducing apparatus.

FIG. 7 is a plan view showing another example of the display screen of the recording/reproducing apparatus.

FIG. 8 is a plan view showing still another example of the display screen of the recording/reproducing apparatus.

FIG. 9 is a plan view showing yet another example of the display screen of the recording/reproducing apparatus.

### BEST MODE FOR CARRYING OUT THE INVENTION

In a recording/reproducing apparatus of the present invention, plural users who operate the recording/reproducing apparatus are associated with contents to be stored in a storage medium so that history information (recording and reproducing history information) of each content item is registered. According to reproduction of the contents, the history information is updated. Then, a reproducing entry showing whether or not each of the users has reproduced the contents is updated, for example. Therefore, when plural users share the storage medium or the contents in the storage medium, each of the content items (contents files) can be managed easily.

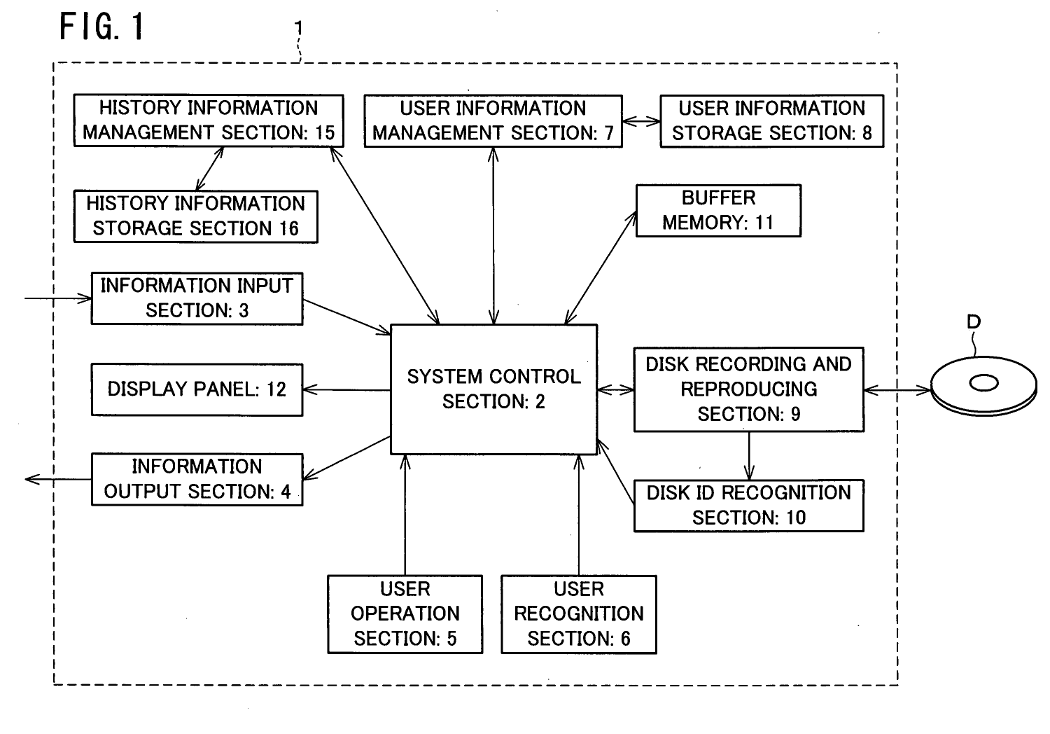

With reference to FIGS. 1 through 9, one embodiment of the present invention is described below.

As illustrated in FIG. 1, a recording/reproducing apparatus 1 includes a system control section (display control section, table display section) 2, an information input section 3, an information output section 4, a user operation section (user setting section) 5, a user recognition section 6, a user information management section 7, a user information storage section (storage area) 8, a disk recording and reproducing section 9, a disk ID recognition section 10, a buffer memory 11, a display panel (display control section, table display section) 12, a history information management section 15, and a history information recording section 16.

The recoding and reproducing apparatus 1 records information (image information, contents) on an optical disk (storage medium) D, or reproduces information recorded on the optical disk D. The recording/reproducing apparatus 1 is used by plural users. According to the present embodiment, the optical disk D is a rewritable optical (disk) and used by plural users.

The system control section 2 controls the recording/reproducing apparatus 1. The system control section 2 is connected to the information input section 3, the information output section 4, the user operation section 5, the user recognition section 6, the user information management section 7, the disk storage and reproduction section 9, the disk ID recognition section 10, the buffer memory 11, the display panel 12, and the history information management section 15.

The system control section 2 receives video information through the information input section 3 from outside of the recording/reproducing apparatus 1, for example. Further, for example, the system control section 2 outputs video information and audios information, which are read out from the optical disk D and sent from the disk storage and reproduction section 9, to external devices such as a display device or a speaker (not shown) through the information output section 4. Also, the system control section 2 controls operations of the foregoing means and data input and output for the respective means, based on the entry operation made by a user through the user operation section 5.

The information input section 3 is an input interface of the recording/reproducing apparatus 1. The information input section 3 outputs externally supplied information to the system control section 2. Upon input of contents (contents data) such as television broadcasting programs for example, the information input section 3 outputs the information to the system control section 2. The information input section 3 may incorporate a decoding function for decompressing compressed motion image data and audios data, or may be configured to receive data distributed from networks. FIG. 1 illustrates only one information input section 3 for simplicity. However, the recording/reproducing apparatus 1 may have a plurality of information input sections 3 to allow various data and signals (digital or analog) to be input.

The information output section 4 is an output interface of the recording/reproducing apparatus 1. The information output section 4 outputs information, such as image information and audio information (contents, contents information), which are recorded on the optical disk D and sent from the system control section 2, to external devices such as a display device (CRT) or a speaker. The information output section 4 can also output user information or history information sent from the system control section 2.

The user operation section 5 is a user interface of the recording/reproducing apparatus 1. Using the use operation section 5, users operate the recording/reproducing apparatus 1. The user operation section 5 is used for entering user information of plural users of the recording/reproducing apparatus 1. The user information may be entered in relation to content information of contents recorded on the optical disk D.

The user information includes user names and passwords, for example, which are used for identifying users. In addition, the user information may include user-specific information such as ages and reproducible programs, for example. The contents information shows details of the contents, including program names, recorded dates, recorded times, classification of contents, and others. Some content information lists titles of the contents, or thumbnail images showing details of the contents on a display.

The user operation section 5 is used for specifying a user of the recording/reproducing apparatus 1 (selecting a user). The user operation section 5 is also used for setting a deletion restricting entry for a desired content item, wherein the deletion restriction entry indicate whether or not the content item can be deleted. A detailed structure of the user operation section 5 will be described later.

The user recognition section 6 recognizes a user of the recording/reproducing apparatus 1. For the authentication or identification of individuals, passwords or fingerprints are used, for example.

The user information management section 7 manages user information of plural users of the recording/reproducing apparatus. The user information management section 7 stores user information, entered through the user operation section 5, in the user information storage section 8, for example. The user information management section 7 manages user information stored in the user information storage section 8. The user information storage section 8 is a storage area for storing user information.

The disk storage and reproduction section 9 is a device for recording or reproducing information (contents) on and from the optical disk D. The disk storage and reproduction section 9 records and reproduces contents under the control of the system control section 2.

The disk ID recognition section 10 recognizes an ID number of the optical disk D recorded and reproduced by the disk storage and reproduction section 9.

The buffer memory 11 is a storage device of the recording/reproducing apparatus 1, and used for decompressing and reproducing compressed motion images, sounds, and other information stored in the optical disk D. The information in the buffer memory 11 can be sent in and out of the system control section 2. Further, the information in the buffer memory 11 can be updated based on instructions from the system control section 2. Use of the buffer memory 11 is not limited to this.

The display panel 12 of the present embodiment is a liquid crystal display panel connected to the recording/reproducing apparatus 1. The display panel 12 displays control information in the recording/reproducing apparatus 1. The display panel 12 of the present embodiment displays not only control information, but also image information and other information stored in the optical disk D.

The history information management section 15 manages and stores recording and reproducing histories of contents for each of the registered users (history information, recording and reproducing history information). The history information storage section 16 is a storage area for storing history information.

As used herein, the history information (recording and reproducing history information) means recorded history information or reproduced history information. Thus, it can be expressed as recording or reproducing history information. The history information includes entries indicative of, for example, users who have recorded contents, users allowed to reproduce contents, users who have reproduced contents, users who have not reproduced contents. That is, in the history information of the present embodiment, the users and contents are associated with each other. The history information may include recorded dates and times, and reproduced dates and times.

For example, when a user records contents, the history information management section 15 sets a recording entry, indicative of the user who has recorded the contents, in the history information in the history information storage section 16. Further, when a user reproduces contents, the history information management section 15 updates a reproducing entry, indicative of the user who has reproduced the contents, in the history information in the history information storage section 16.

In the present embodiment, the user information storage section 8, the buffer memory 11, and the history information storage section 16 are realized by rewritable semiconductor memories such as a flush memory. However, the invention is not limited to this example, and harddisks or other disk media may be also used. The user information storage section 8 may be a single unit storage section shared with the buffer memory 11 and the history information storage section 16.

The following will describe details of the user operation section 5 of the present embodiment.

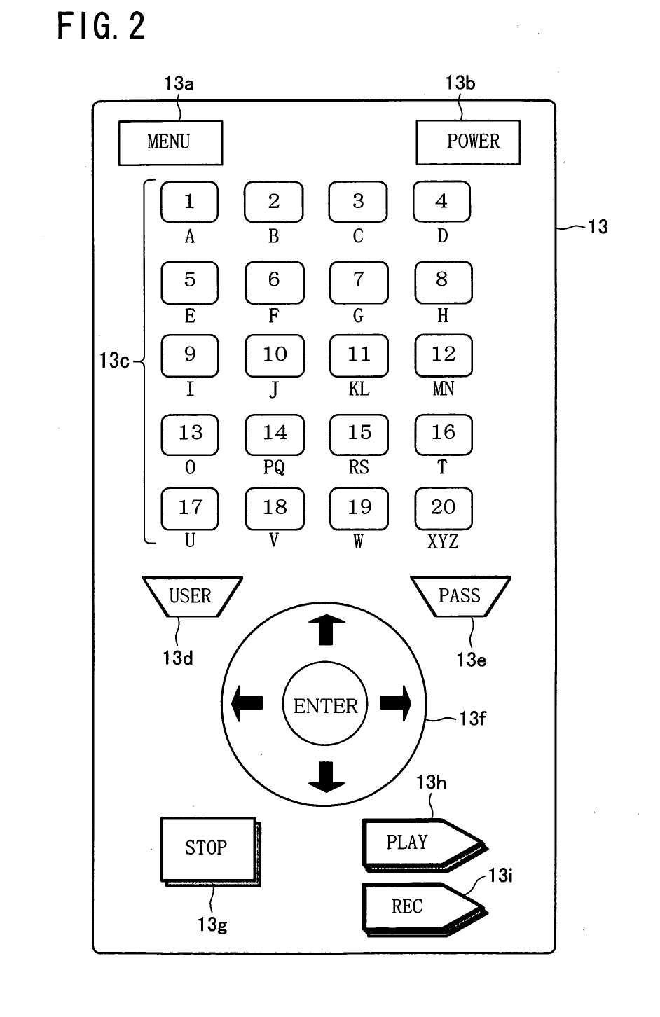

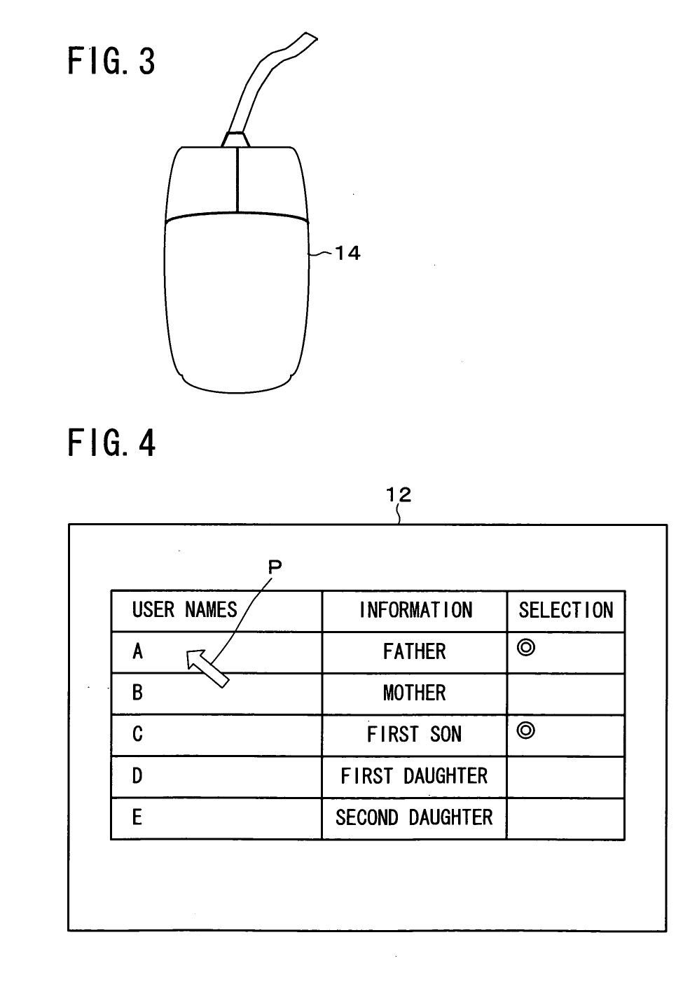

As illustrated in FIGS. 2 and 3, the user operation section 5 includes a remote controller (user setting section) 13 and a mouse (user setting section) 14, as examples of pointing devices.

As illustrated in FIG. 2, the remote controller 13 is a remote controller for audio-video devices. The remote controller 13 includes a menu (Menu) button 13a, a power (Power) button 13b, numeric buttons 13c, a user (User) button 13d, a password (Password) button 13e, a move-and-select (Enter) button 13f, a stop (Stop) button 13g, a playback (Play) button 13h, and a record (Record) button 13i.

The menu button 13a is used for displaying menus available for users in the recording/reproducing apparatus 1. The power button 13b is used to turn on and off the recording/reproducing apparatus 1.

The numeric buttons 13c are used for selecting stations in an ordinary manner, as in selecting channels of television broadcasting programs, for example. The numeric buttons 13c of the present embodiment include 20 buttons with numbers 1 through 20 as illustrated in FIG. 2. With the increasing number of accessible television stations in these years, it is not unusual to have 20 buttons.

The numeric buttons 13c are assigned with alphabets (A to Z) as illustrated in FIG. 2, for example. This enables a user to enter user information such as user names with the numeric buttons 13c. For setting and entering passwords, numbers such as 1, 5, 16, and 10 may be combined in order, or alphabets may be used, for example. By using the numeric buttons 13c, Japanese letters can be also entered in roman alphabets. In this case, it is possible to enter user information in Japanese.

The user (User) button 13d is used for displaying a user selection screen. With the user button 13d, the user selection screen is displayed as shown in FIG. 4, for example. User selection is made to determine which user has recorded or reproduced (viewed) contents. Users can be selected by moving a pointer P on the display panel 12 with the move-and-select button 13f, for example. In this manner, using the pointing device makes operations easier in selecting and deciding information, for example. As shown in FIG. 4, for example, the result of selection is displayed in a column under “selection”. Alternatively, a selected user may be indicated by displaying the user name in a different color, for example. Further, user information registered in the recording/reproducing apparatus 1 can be added, modified, or deleted.

Referring back to FIG. 2, the password (Password) button 13e is used for entering passwords in selecting users.

The move-and-select button 13f is a pointing device capable of moving upward, downward, left and right. Thus, with the move-and-select button 13f, the pointer P appearing on the display panel 12 can be moved to select a user.

The stop button 13g is used to stop the recording or reproducing operation in the recording/reproducing apparatus 1. The playback button 13h is used to start the reproducing operation in the recording/reproducing apparatus 1. The record button 13i is used to start the recording operation in the recording/reproducing apparatus 1.

The mouse 14 illustrated in FIG. 3 is a pointing device commonly used in personal computers (PC). With the mouse 14, the pointer P appearing on the display panel 12 shown in FIG. 4 can be moved to select a user.

As described above, the user operation section 5 of the present embodiment includes the remote controller 13 and the mouse 14. However, the present invention is not just limited to this example, and other pointing devices can also be used for the user operation section 5, from among various types of pointing devices in actual use.

User information entered or selected through the remote controller 13 for example is stored not only in a storage medium such as the optical disk D, but also in the user information storage section 8 of the recording/reproducing apparatus 1. Therefore, user information of all users can be displayed at the startup of the recording/reproducing apparatus 1, even when a storage medium is not inserted in the recording/reproducing apparatus 1. Further, user information of users of the recording/reproducing apparatus 1 can be entered without inserting a storage medium in the recording/reproducing apparatus 1.

In this manner, user information of users of the recording/reproducing apparatus 1 is entered in the user information storage section 8 of the recording/reproducing apparatus 1. Note that, users and user information stored in the recording/reproducing apparatus 1 need not always to match users and user information stored in the optical disk D. A user of the recording/reproducing apparatus 1 can select which information is to be displayed.

In recent optical disk storing and reproducing devices, various kinds of storing and reproducing conditions, for example, such as laser power, tilt correction of a disk, and aberration correction need to be decided and set for recording or reproducing. Therefore, it may take at least several ten seconds before the optical disk D inserted in the device becomes ready for recording or reproducing. Thus, when user information is stored in the optical disk D for example, the user information is read after the lapse of several ten seconds or longer.

On the other hand, in the recording/reproducing apparatus 1 of the present embodiment, user information is not stored in the optical disk D but in a device (the user information storage section 8) that can read information relatively quickly, such as a semiconductor memory in the recording/reproducing apparatus 1. This enables user information to be read out and displayed during a waiting time in which the optical disk D becomes ready for recording or reproducing. Thus, user entry or various settings of viewers can be made efficiently.

The optical disk D of the present embodiment stores contents data including video information and audio information. The optical disk D may be, for example, a rewritable digital versatile disk (DVD), which requires initialization for reproducing contents. The storage medium is not limited to an optical disk, and a magnetooptical disk or a magnetic disk can also be used. The type of data stored in the optical disk is not just limited to the foregoing examples, which include contents data (contents), user information, content information, and history information.

In recording contents on the optical disk D using the recording/reproducing apparatus 1 as configured above, the contents data sent from the system control section 2 through the information input section 3 is stored in the optical disk D after it is converted by the disk storage and reproduction section 9 into a recordable form on the optical disk D. Here, the data is displayed on the display panel 12.

In reproducing contents using the recording/reproducing apparatus 1 as configured above, a user selects a necessary content item using the user operation section 5. As a result, a content number of the selected content item is notified to the system control section 2.

Thereafter, the disk storage and reproduction section 9 of the recording/reproducing apparatus 1 selects the contents data stored in the optical disk D, converts the data into a reproducible form in the information output section 4, and outputs the data to the system control section 2. Here, the data is displayed on the display panel 12.

In initializing the optical disk D with the recording/reproducing apparatus 1, the initialization of the optical disk D is carried out based on instructions from the system control section 2. Completion of the initialization of the optical disk D is notified to the system control section 2.

The recording/reproducing apparatus 1 can also display history information. When displayed users or contents are selected through an external input device such as the user operation section 5, the selection is notified to the system control section 2. Then, the history information is displayed on the display panel 12.

Details of the operations are described below. A following method is employed for managing a plurality of users so that plural users can operate the recording/reproducing apparatus 1.

First, user entry to be carried out prior to recording or reproduction is described. The recording/reproducing apparatus 1 requires entry of user information of a user when the recording/reproducing apparatus 1 is used for the first time after the purchase, or when it is needed. That is, user information of plural users of the recording/reproducing apparatus 1 is entered using the user operation section 5.

For example, when the recording/reproducing apparatus 1 is used for the first time after the purchase, the user button 13d of the remote controller 13 shown in FIG. 2 is pressed to display a user entry (addition) screen. Under this condition, user information of all users is entered, or new users and new user information are added. In the present embodiment, in the user selection screen shown in FIG. 4, user names, information related to the users (information), and passwords are entered in the respective columns. User names and passwords are least required entries of user information. The user information is stored in the user information storage section 8 provided in the recording/reproducing apparatus 1.

Then, in normal use, based on the user information stored on the user information storage section 8, the user selection screen is displayed on startup of the recording/reproducing apparatus 1. Thus, users can be selected. In accordance with the user selection and the result of subsequent recording or reproduction of contents, history information in which content information of the contents and each of the registered users are associated with each other is stored and updated.

The user selection screen shown in FIG. 4 is displayed on the display panel 12, for example. Then, using the pointer P, users to use the recording/reproducing apparatus 1 are selected in the column under “selection.” In FIG. 4, users “A” and “C” are selected, as indicated in the “selection” column.

Note that, the input device used is not limited to the remote controller 13. For example, the input device may be part of the user operation section 5 of the recording/reproducing apparatus 1 and provided in a main unit of the recording/reproducing apparatus 1. However, with the remote controller 13, entry and selection become easier since the numeric buttons 13c or the move-and-select button 13f are used.

Further, by selecting a user name with the pointer P from the user selection screen shown in FIG. 4, a reproducing status of the user associated with the contents stored in the optical disk D may be displayed. Further, by selecting a content item with the pointer P from the reproducing status of the user, reproducing statuses of the respective users associated with the contents may be displayed. These operations will be described later.

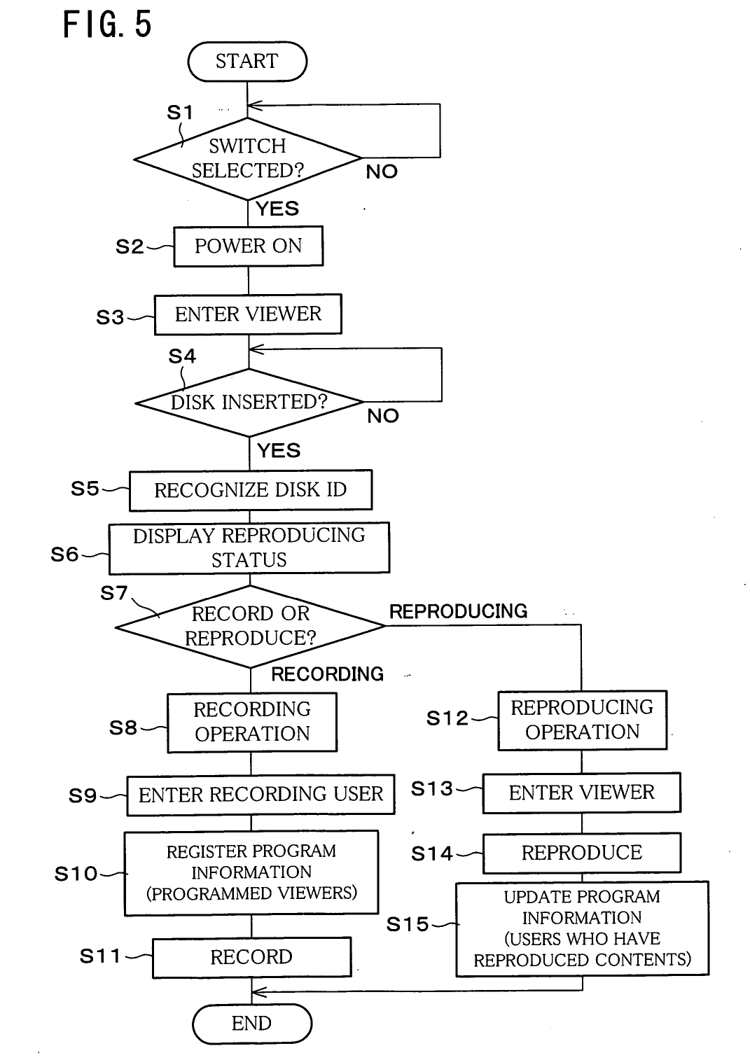

With reference to FIG. 5, the following will describe recording and reproducing operations carried out on the optical disk D of the recording/reproducing apparatus 1. It is assumed here that the storing and reproducing operations are carried out in the recording/reproducing apparatus 1 in which user entry and user selection were carried out in the manner described above.

First, selecting the power button 13b of the remote controller 13 in step S1 turns on the recording/reproducing apparatus 1 in S2. In the present embodiment, the recording/reproducing apparatus 1 is also turned on (S2) when the playback button 13h or the record button 13i of the remote controller 13 is selected (S1).

In S3 after S2, user (viewer) entry (selection) is made. For example, when reproducing contents stored in the optical disk D, entry is made for a user (viewer) of the contents. When recording (storing) and reproducing a television broadcasting program for example, entry is made for a user (viewer) of the program.

For startup user entry, user selection is made in the user selection screen shown in FIG. 4. When user information has not been entered, a user is selected after user registration. In the present embodiment, as described above, user information is stored beforehand in the user information storage section 8 of the recording/reproducing apparatus 1. Therefore, pressing the user button 13d of the remote controller 13 causes the system control section 2 to display the user selection screen as shown in FIG. 4 on the display panel 12. That is, users registered in the user information storage section 8 are displayed so that users who will use the recording/reproducing apparatus 1 can be selected. By moving the pointer P, users “A” and “C” are selected.

As described above, the user information of the users who will use the recording/reproducing apparatus 1 is registered beforehand in the user information storage section 8 of the apparatus. Therefore, when the recording/reproducing apparatus 1 is booted, information of the registered users is read out almost concurrently from the user information storage section 8, and necessary information in the information can be displayed on an external display through the display panel 12 or the information output section 4. From the displayed user information, users who will reproduce or record contents can be selected. Further, user information of the user set in S3 may be updated by regarding him or her as the user who will record or reproduce contents on and from the optical disk D in a subsequent step. This will be described later in more detail.

In S3, user authentication may be carried out using the user recognition section 6. This can be made, for example, by using passwords entered as user information. Alternatively, the system control section 2 may verify entered information with the entered user information, so as to determine whether or not the user is a valid user of the contents. In this case, if the result of determination finds that the user is valid, the sequence goes to the next step. If not, the result is displayed and the process may be finished. In the event where user authentication is to be carried out for multiple users, authentication may be carried out for each of the users. Alternatively, it may be carried out only for a representative user of the users according to the user information for example. In this way, time and effort for authentication can be saved.

In S4 after S3, it is determined whether or not the optical disk D is inserted in the recording/reproducing apparatus 1 for recording or reproducing. If the optical disk D has been inserted, the sequence proceeds to the next step S5. If not, S4 is repeated. Note that, when the optical disk D is not inserted, an instruction may be displayed on the display panel 12 to prompt a user to insert the optical disk D.

In S5, the disk ID recognition section 10 recognizes an ID of the optical disk D. This enables recorded contents to be read out (reproduced) from the optical disk D. It also becomes possible to records contents on the optical disk D. Note that, the information of the stored contents can be obtained from stored information (TOC) of the disk even when the ID cannot be recognized.

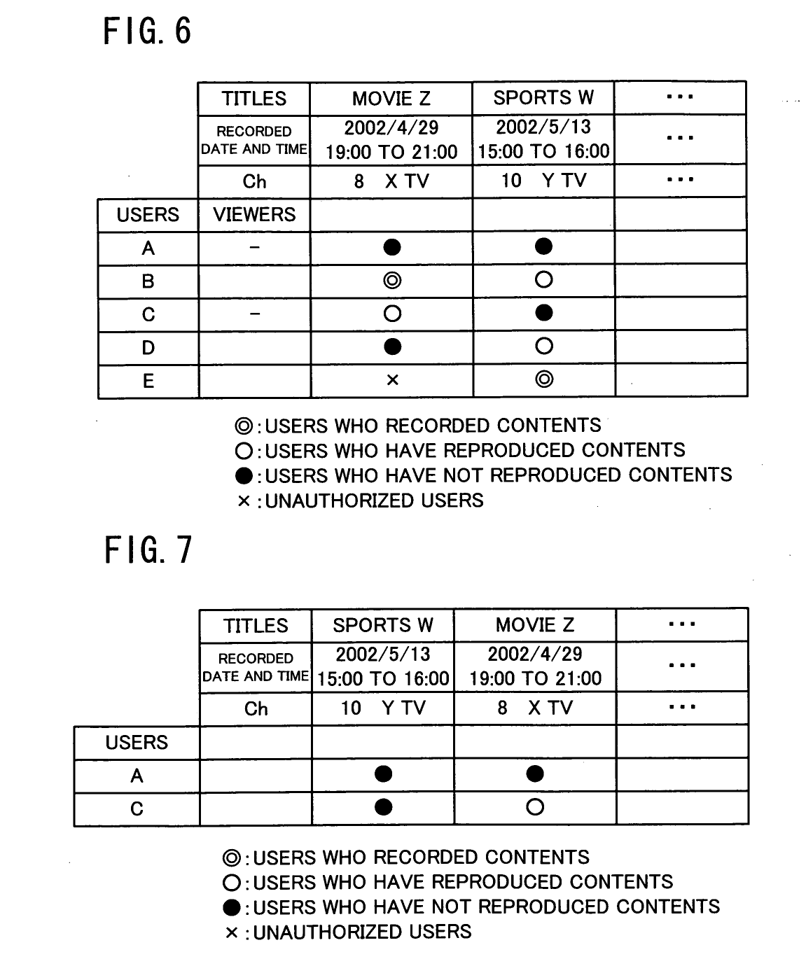

With the contents information obtained for each content in S5 in the recording/reproducing apparatus 1, the system control section 2 displays history information (table) of plural users on the display panel 12 in S6, as shown in FIG. 6 for example, and the sequence goes to S7.

The history information represented in FIG. 6 is a table relating recorded contents on the optical disk D to registered users of the recording/reproducing apparatus 1. That is, when content information is obtained in S5, history information that relates the contents information to the user information stored in the user information storage section 8 is created by the history information management section 15, or extracted from the history information storage section 16. When the history information storage section 16 contains no items for the relevant history information, the history information management section 15 creates a new entry, for example. When the history information storage section 16 contains entries for the relevant history information, the history information management section 15 extracts the relevant entries from the history information storage section 16, for example. Then, the system control section 2 displays the relevant entries in a table on the display panel 12 in S6.

In the present embodiment, as shown in the column under “viewer” in FIG. 6, “A” and “C” are selected as viewers. Titles, recorded dates and times, and channels are also displayed as content information of the contents stored on the optical disk D.

In the table shown in FIG. 6, the vertical cells indicate users, and the horizontal cells indicate contents. When registered users and contents are specified, reproduced histories of contents reproduced by the users are recognized (whether the users have or have not reproduced the contents). In the present embodiment, it can be also recognized whether the contents have been recorded by the users.

Here, plural users (A and C) are selected at the startup (S2). In this case, with the table shown in FIG. 6 displayed on the display panel 12, pressing for example the menu button 13a of the remote controller 13 may cause unreproduced contents common among the selected users to be read out from the history information storage section 16, and retrieved and displayed, as shown in FIG. 7. In FIG. 7, common unreproduced contents are displayed on the left column by priority, for example. In the case of three or more viewers, the content item to be reproduced by the greatest number of users is placed on the left, and the other content items are placed in order of decreasing number of users. In this way, the result of unreproduced content retrieval can be displayed in an easy to read manner.

The display functions may be operated by pressing the buttons provided on the remote controller 13, or selected with the pointer P appearing on the display panel 12.

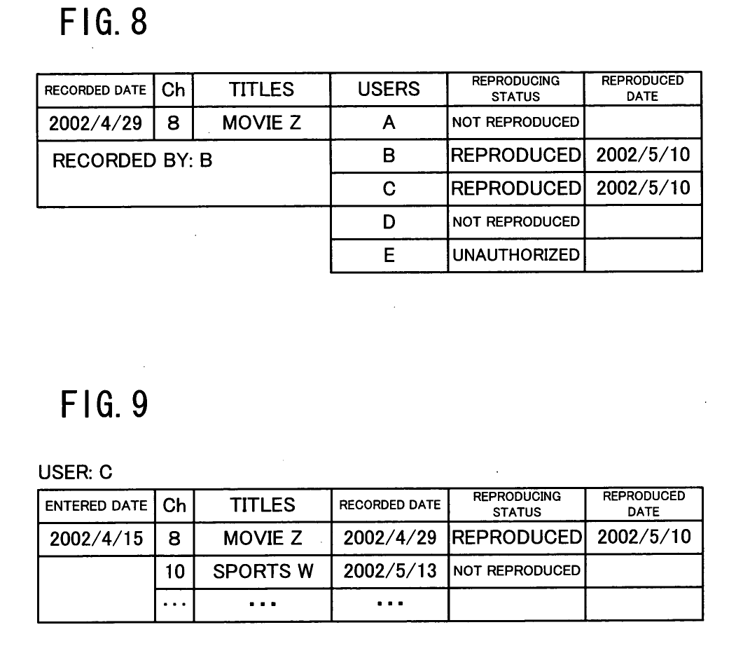

In the display showing the reproducing conditions of plural users in FIG. 6, selecting a program column with the pointer P may cause information of the program to be displayed, for example. For example, when the content item with the title “Movie Z” is selected, information on the content item may be displayed, as shown in FIG. 8. FIG. 8 is one example of a reproducing condition display method for each content item, which can be realized in managing plural users in the recording/reproducing apparatus 1. That is, as shown in FIG. 8, when one of the content items stored in the optical disk D is selected, reproducing conditions of the respective users are read out from the history information storage section 16 and displayed only for the selected content item. In addition to the reproducing conditions, it is possible to display an item concerning reproduced dates for users who have reproduced the contents.

Further, in the display showing the reproducing conditions of the plural users shown in FIG. 6, selecting a program column may cause history information of the users to be read out from the history information storage section 16 and displayed, for example. As shown in FIG. 9, when user “C” is selected, the reproducing conditions of only the user C may be displayed, for example. FIG. 9 is one example of the reproducing condition display method for each content item, which can be realized in managing plural users in the recording/reproducing apparatus 1. That is, as shown in FIG. 9, by selecting one of the users, the reproducing conditions concerning the respective content items stored in the optical disk D are displayed only for the selected user.

Note that, by pressing the buttons provided on the remote controller 13 for example, a display status of either FIG. 6, 7, 8, or 9 is suitably selected.

As shown in FIG. 6, for the title “Movie Z”, user “E” is a non-approved user (x). The non-approved user means that the user is restricted to reproduce or delete contents. That is, the user “E” can neither reproduce nor delete the title “Movie Z”.

The deletion restriction entry can be set using the user operation section 5. The deletion restriction on the title “Movie Z” is set when the content is recorded, for example. That is, in the user selection screen described with reference to FIG. 4 as an example, not only viewers but also unauthorized viewers are selected. In this case, in the user selection screen shown in FIG. 4 for example, an entry showing whether or not the users can reproduce contents may be displayed to allow for user selection. Alternatively, after selecting a user, whether or not the user can reproduce contents can be selected by, for example, pressing the user button 13d on the remote controller 13.

Further, by selecting a user who is restricted to delete contents in the entry indicating deletion restriction, the reproducing restriction may be imposed on the user. Conversely, by setting the reproducing restriction, the user may be restricted to delete contents in the entry indicating deletion restriction. In this manner, the item for deletion restriction may also be used to set reproducing restriction. In this way, user management can be simplified even when many users share the recording/reproducing apparatus 1.

In the next step S7, it is determined whether the operation performed on the optical disk D is recording or reproducing. For example, when the record button 13i or the playback button 13h is pressed in S1, it is determined whether to perform recording or reproducing according to which button was pressed. Alternatively, for example, instructions for pressing the record button 13i or the playback button 13h may be displayed on the display panel 12, so as to allow for detection of the button pressed by a user.

When recording is selected in S7, the recording operation is performed in S8. The recording operation corresponds to a setting for normal recording. Thus, contents to be recorded are selected and a recording mode is set, for example.

In S9 after S8, a user performing a recording operation (a person responsible for recording, recording user) is registered in regard to the content to be recorded. In the present embodiment, the user registered in S9 is the one selected in S3 with the power is on in S1 and S2. However, a new user may be selected in S9. Here, a user who performs the recording operation is registered because it allows the user to be automatically registered as a viewer. For example, viewer settings required for canceling the deletion restriction on contents can be simplified. The user selected here will be displayed as a recording user, as shown in FIG. 6 for example.

When a new user is selected, all users stored in the user information storage section 8 may be displayed again so that a new user can be selected using the user operation section 5. Further, a user may be reselected from users, registered in S3, at the startup of the recording/reproducing apparatus 1. For reserved recordings, a user is set when making reservations. In most cases, users registered in S3 on startup generally become the recording users. Therefore, the users selected on startup may be automatically registered as recording users. Alternatively, after the recording operation is finished, user entry may be carried out is S9. In general, the recording operation in S8 requires operating the record switch, so that the recording operation in S10 is generally followed.

In S10 after S9, content information on new contents to be stored (program names, recorded dates, recorded times, classification of details) is registered. The registration causes the content information to be stored in the optical disk D.

Further, the history information management section 15 stores programmed viewers in the history information storage section 16 by associating it with content information. The history information management section 15 also stores recording users in the history information storage section 16 by associating it with content information. In this manner, history information of plural users using the recording/reproducing apparatus 1 is registered by being associated with the contents stored in the optical disk D.

Further, according to storing of the content information, the reproducing restriction and the deletion restriction for the contents may be set for the respective programmed viewers. That is, the history information management section 15 may store the reproducing restriction entry and the deletion restriction entry in the history information storage section 16.

The history information may be stored at the completion of recording (after S11) or before the completion of recording (before S11), as long as recording users have been selected (S9). In the recording/reproducing apparatus 1 shown in FIG. 1, the history information is stored in the history information storage section 16 provided in the apparatus. However, the history information may be also stored in the optical disk D. In this case, because the contents in the optical disk-D are updated after the completion of recording (after S11), it is more efficient to record the history information on the optical disk D after the completion of recording.

In S11 after S10, recording is performed. In the case that contents are reproduced by all programmed viewers when the contents are being recorded, the contents can be deleted. That is, when users registered in S3 and programmed viewers registered in S10 are the same, contents recorded in S11 can be deleted later. Therefore, in this case, it may be displayed on the display panel 12 that contents will not be recorded, and the recording operation may be omitted. In this way, a storage area can be saved in the optical disk D.

On the other hand, when reproducing is selected in S7, a reproducing operation is performed in S12. The reproducing operation corresponds to a setting for normal reproducing. For example, contents to be reproduced are selected and a reproducing mode is set. Note that, in regard to the contents to be reproduced, programmed users have been stored as history information when the contents were recorded, for example.

When the history information contains information of whether or not users can reproduce respective content items (reproducible user information), for example, whether or not the users can reproduce the contents can be determined using the information of the users specified in S3 and the history information. In this case, the process is terminated if reproducing is unallowable. If allowable, the sequence goes to S13.

In S12, contents that have not commonly reproduced by the viewers, entered in S3, may be selected and displayed as the contents to be reproduced, for example. That is, the table shown in FIG. 7 may be displayed on the display panel 12, for example. Such a process is possible since the relationship between contents and users have been registered in the history information in the present embodiment. In this way, with a simple operation, it is possible to retrieve target contents even when reproduced by plural users.

In S13 after S12, viewer entry is made. As in the storing operation, users are selected in S3 after startup of the apparatus. Thus, user entry may be omitted as being the same as in S3. The selection may be made using the user operation section 5, for example. Alternatively, user entry may be made in S13 after the completion of reproducing operation (S14). In general, reproducing operation S12 requires operating the playback switch, so that the reproducing operation S14 is generally followed.

When the history information contains information of whether or not users can reproduce the respective content items, for example, whether or not the users can reproduce the contents can be determined using the information of the users specified in S13 and the reproducible user information stored in the history information.

That is, as shown in FIG. 6 for example, for the title “Movie Z,” user “E” is a non-approved user (x). In this case, when “E” attempts to reproduce the “Movie Z”, it is determined that reproducing is not possible. With reference to the example of FIG. 6, reproducing is possible in other cases. Here, the process is terminated if reproducing unallowable. If reproducing is allowable, the sequence goes to S14.

In S14 after S13, the recording/reproducing apparatus 1 reproduces selected contents. The contents are reproduced by the users entered as viewers.

In S15 after S14, in order to record that the contents were actually reproduced, the history information management section 15 updates the contents' history information (reproducing entry) stored in the history information storage section 16, concerning users who have actually reproduced the contents.

After updating the history information (reproducing entry) to “reproduced,” the history information management section 15 may set the deletion restriction entry concerning the user-content to “deletable.” In this case, when the history information management section 15 determines that the deletion restriction entry has been set to “deletable” for all users, the content may be deleted since reproduced contents can be deleted.

If the history information storage section 16 has not stored entries concerning the history information for viewers associated with the content, the history information management section 15 may create an entry (reproducing entry) in S15, and store the entry in the history information storage section 16.

Further, in S15, a table created with the updated history information may be displayed on the display panel 12, as shown by the table in FIG. 6

With the update, reinserting the optical disk D after reproducing displays an indication “reproduced” in the cells of the respective users, as shown in FIGS. 6 and 7. Together, the cells of the users who have reproduced the programs change the indication to “reproduced”, as shown in FIGS. 8 and 9.

As for the content (program) information, detailed information can be acquired from an electronic programming guide (EPG). Therefore, additional columns may be provided to display the programs.

As described above, in the recording/reproducing apparatus 1 of the present embodiment, the reproducing entry is updated for a plurality of users of the recording/reproducing apparatus 1 according to reproduction of contents. The reproducing entry indicates, for each content item stored in the optical disk D, whether or not the user has reproduced the content.

In this manner, when the optical disk D is shared, contents stored in the optical disk D are associated with the reproduced or unreproduced status of the user, and managed as history information. Since the information is displayed in the form of a table on the display panel 12 for example, the other users can also check the reproducing status of the contents. Therefore, the user can determine whether or not the reproduced contents can be deleted. By deleting the contents, the storage capacity of the optical disk D can be restored, enabling new contents to be recorded.

The user names used for the user information may be user names previously defined by the recording/reproducing apparatus 1. For example, simple numbers such as “A”, “B”, and “C”, or words such as “Father (F)”, “Mother(M)”, “Brother1(B1)”, “Brother2(B2)” may be used. In this case, the step of registering user information (user registration carried out prior to storing and reproducing operations) can be omitted.

Further, in this case, in order to make a reproduction request, user-specific information such as “A” or “F” is entered. Here, “F” stands for “Father” and is used to simplify the entry.

In this manner, when using previously defined user names, it is required to determine among users which user names are to be used. However, since the user is not requested to set user information, using pre-defined user names is more convenient.

The history information contains contents and user information. Therefore, in addition to the distinction between reproduced contents and unreproduced contents (reproduced history), information indicative of deletion prohibition (deletion restriction) may be set on each content item. For example, an entry for deletion restriction may be set in addition to the reproducing restriction entry. In this case, when contents and users are specified, the deletion restriction entry, as well as the reproduced history can be acquired. The deletion restriction may be set in S11 at the completion of recording, for example. Also, the deletion restriction may be canceled in S15 at the completion of reproducing. In this way, even reproduced contents can be protected from being deleted by users who are not associated with the contents. Thus, the deletion restriction is effective when keeping the stored contents for a certain period of time or permanently.

According to the arrangement, the deletion restriction entry may be contained in at least one of the history information or the content information. That is, the deletion restriction entry may be contained in the content information and stored in the storage medium, for example. In this case, the contents can be deleted in other recording/reproducing apparatuses. Further, the deletion restriction entry may be associated with the history information or the user information. Also, the deletion restriction entry may be registered by being associated with the user information, so that predetermined users can delete all contents while other predetermined users are prohibited from deleting contents, for example.

As described above, in the recording/reproducing apparatus 1, the method for managing plural users simplifies user management and content management, when information is stored and reproduced on a storage medium with large capacity, shared by plural users, and capable of storing more contents.

In the recording/reproducing apparatus 1, the history information enables displaying reproducing conditions of plural users as shown in FIG. 6 or 8, when the plural users reproduce a single program or content. That is, information such as who have reproduced contents, when contents were reproduced, whether contents have been reproduced etc. is displayed in regard to each program or content. As a result, the information allows a user to determine which content item can be deleted, for example. Thus, it is possible to select contents that can be deleted, when an available storage medium does not have sufficient hours for recording a new program, for example.

The foregoing described a method for managing plural users of the recording/reproducing apparatus, and a storage device using the method (recording/reproducing apparatus), which allow contents such as motion images, audios, or television broadcasting programs to be stored and shared by plural users.

In these years, various types of devices which store contents including motion images, audios, and others have been developed. Specially, the capacities of optical disk devices have been rapidly increasing with the actual application of blue lasers.

The available storage capacity of a single disk is about 4.7 GB in a rewritable DVD, for example. However, optical disks with the capacity of 25 GB or more have been released as next-generation optical disks. With the increased capacity, five-times or more recording or reproducing hours can be realized with the same image quality as DVD. As a result, the disks are replaced less often, and more contents can be stored in a single disk. In this case, when a disk is shared, the number of users who store contents also increases. That is, plural users share a single storage medium. When image contents are stored, contents stored in the storage medium are also to be shared by plural users, for example.

In this manner, when plural users store many contents in a single disk, a method is required for checking who has reproduced or has not reproduced the stored contents. That is, it is necessary to check user reproducing information indicative of a reproducing status of each content item for each user.

Without the user reproducing information, a user cannot immediately determine who in the family have reproduced or has not reproduced contents if all family members do not have a chance to reproduce the program recorded for later reproducing, for example. Further, the user cannot determine whether the recorded program can be deleted to record new contents.

That is, according to the conventional arrangement, it is not possible to display contents that plural users have not reproduced, or delete contents that all users have reproduced, for example.

Thus, as described above, the present invention enables managing a plurality of user information such as who have reproduced, not reproduced, or stored each content item stored in the storage medium.

More specifically, the recording/reproducing apparatus includes the history information storage section that store user information of plural users indicative of whether who has reproduced or has not reproduced contents stored in the medium. As a result, file management can be simplified in the storage medium that is shared by plural users and stores many contents.

Note that, the personal computer (PC) is a representative example of an apparatus used to manage a plurality of users. A method for managing users in a PC is disclosed in Japanese Laid-Open Patent Publication No. 35092/2001 (Tokukai 2001-35092).

However, despite that fact that the PC assumes use by plural users, generally, only a single user use the PC at one time. Therefore, unlike televisions or AV devices connected to televisions, plural users cannot enjoy operating the PC at the same time. Thus, a user who has stored a content item is supposed to be a viewer, which has not been a problem. As a result, reproducing and storing of content as information of plural users has not been recognized as a problem.

The conventional AV devices such as VCR have short recording hours on a single tape or disk. Therefore, it has been sufficient to write details of recorded contents on labels. Also, so-called reproducing history information of respective users is not recorded on the tapes or disks. Therefore, there has been no method for retrieving information of respective users, and users who have reproduced or not reproduced contents.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims. Further, the scope of the claims and the technical means described in the best mode for carrying out the invention can be combined as appropriate, and the combined scope is also included in the scope in the art of the present invention.

### INDUSTRIAL APPLICABILITY

In a recording/reproducing apparatus of the present invention, reproducing history of contents stored in a storage medium is managed for each user. Therefore, the recording/reproducing apparatus can be used at home and shared by a plurality of users, for example.

1. A recording/reproducing method for a recording/reproducing apparatus which records and reproduces contents on and from a storage medium,
said method comprising the step of updating history information in which content information of contents stored in the storage medium is associated with user information of a plurality of users using the recording/reproducing apparatus and in which a reproducing entry indicative of whether the users have reproduced the contents is contained, said history information being updated responsive to reproduction of the contents and in regard to the reproducing entry concerning a user who has reproduced the contents.

2. The method as set forth in claim 1, further comprising the step of displaying the user information, registered in the recording/reproducing apparatus, so as to allow for selection of users using the recording/reproducing apparatus.

3. The method as set forth in claim 1, further comprising the steps of:
registering a user of the recording/reproducing apparatus in a storage area of the recording/reproducing apparatus at or after the startup of the recording/reproducing apparatus; and
setting, when the user has recorded contents on the storage medium, a recording entry in the history information in regard to the user registered in the user registering step, so as to indicate that the user has recorded contents on the storage medium, or, when the user has reproduced contents from the storage medium, updating the reproducing entry in the history information in regard to the user registered in the user registering step, the setting or update being carried out at a point in between the recording/reproducing apparatus being started up and the recording/reproducing apparatus being turned off.

4. The method as set forth in claim 1, further comprising the step of setting a deletion restriction entry in regard to a desired content item, the deletion restriction entry indicative of whether deletion of content is allowable or unallowable, and the deletion restriction entry being contained in the history information or being contained in the content information and associated with the history information.

5. The method as set forth in claim 1, further comprising the steps of:
creating, based on the history information, a table in which contents represented by the content information and users represented by the user information are associated with each other; and
displaying the table.

6. A recording/reproducing method comprising the steps of:
entering and storing user information containing at least identification information specific to a user, the user information being entered and stored for at least one user of a recording/reproducing apparatus which records and reproduces contents on and from a storage medium;
storing history information in which the user registered in the user information is associated with the contents, the history information being stored for each content item recorded on the storage medium;
receiving a reproducing request for the recorded content item from a user registered in the user information;
checking the users contained in the history information with the user who has made the reproducing request, in regard to the content for which the reproducing request was made;
making, when the users accord, instructions for reproducing the content, and updating, after reproducing the content, the history information so that a combination of the content and identification information for specifying the user who has made the reproducing request includes additional information which indicates that the content has been reproduced; and
outputting information indicative of a relationship between (i) the identification information for specifying the user who has made the reproducing request, (ii) the content information, and (iii) the presence or absence of information which indicates that the content has been reproduced.

7. A recording/reproducing apparatus for recording and reproducing contents on and from a storage medium, said recording/reproducing apparatus comprising:
a user information managing section for managing user information concerning a plurality of users of the recording/reproducing apparatus; and
a history information managing section for managing history information in which content information of contents recorded on the storage medium is stored, and in which a reproducing entry indicative of whether the contents have been reproduced by users is contained, wherein the history information managing section updates the reproducing entry responsive to reproduction of the contents and in regard to a user who has reproduced the contents.

8. The recording/reproducing apparatus as set forth in claim 7, further comprising:
a storage area, provided in the recording/reproducing apparatus, for enabling the user information managing section to register the user information; and
a display control section for displaying listings of users whose user information is stored in the storage area, so as to allow for user selection by users using the recording/reproducing apparatus.

9. The recording/reproducing apparatus as set forth in claim 7, comprising a user setting information,
wherein the history information managing section sets, when the user has recorded contents on the storage medium, a recording entry in the history information in regard to the user set in the user setting section, so as to indicate that the user has recorded contents on the storage medium, or the history information managing section updates, when the user has reproduced contents from the storage medium, the reproducing entry in the history information in regard to the user set in the user setting section, the setting or update being carried out at the startup of the recording/reproducing apparatus or after the startup of the recording/reproducing apparatus.

10. The recording/reproducing apparatus as set forth in claim 7,
wherein the history information or the content information includes a deletion restriction entry indicative of whether deletion of content is allowable or unallowable, and the deletion restriction entry in the content information is associated with the history information, and
wherein said history information managing section sets the deletion restriction entry in regard to a desired content item.

11. The recording/reproducing apparatus as set forth in claim 7, comprising:
a table display section for creating, based on the history information, a table in which the user information managed by the user information managing section is associated with the content information of the contents recorded on the storage medium, and displaying the table.

12. The recording/reproducing apparatus as set forth in claim 7, wherein the reproducing entry contained in the history information managed by the history information managing section includes an entry indicative of date and time that the content was reproduced by the user.

13. The recording/reproducing apparatus as set forth in claim 10, wherein, when updating the reproducing entry for the user who has reproduced the content, the history information managing section sets the deletion restriction entry such that the user is allowed to delete the content.

14. The recording/reproducing apparatus as set forth in claim 10, wherein the deletion restriction entry set by the history information managing section also sets reproducing restriction for the users.
